(19) United States
(12) Patent Application Publication
(10) Pub. No.: US 2026/0351246 A1
(43) Pub. Date: Nov. 5, 2026

(54) Automatic Speech Recognition with Word-Timings Transcribed

(71) Applicant: Google LLC, Mountain View, CA (US)

(72) Inventors: Adam Michael Stooke, San Francisco, CA (US); Olivier Siohan, Mountain View, CA (US); Paul Kishan Rubenstein, Zurich (CH); Qingyun Dou, Mountain View, CA (US)

(73) Assignee: Google LLC, Mountain View, CA (US)

(21) Appl. No.: 19/199,287

(22) Filed: May 5, 2025

(51) Int. Cl. G10L 15/06; G10L 15/05; G10L 15/16

(52) U.S. Cl. CPC G10L 15/063; G10L 15/05; G10L 15/16

(57) ABSTRACT

A method includes obtaining training data that includes a plurality of training utterances each paired with a corresponding target output sequence. Each corresponding target output sequence includes a sequence of words and associated timestamps. Each timestamp indicates a timing associated with one of the words in the sequence of words of the target output sequence. For each respective training utterance, the method includes generating a corresponding audio encoding based on the respective training utterance using an audio encoder, generating a respective speech recognition result based on the corresponding audio encoding using a decoder, and determining a corresponding loss based on the corresponding target output sequence and the respective speech recognition result. The method includes training a speech recognition model based on the corresponding loss determined for each respective training utterance of the plurality of training utterances.

### TECHNICAL FIELD

This disclosure relates to automatic speech recognition with word-timings transcribed.

### BACKGROUND

Automatic Speech Recognition (ASR) systems generate text transcriptions from audio, but numerous applications, such as video captioning, additionally require precise word-timing information indicating when each word was spoken. For instance, in video captioning, accurate word timings are essential for synchronizing the display of captions with the corresponding spoken content. Similarly, meeting captions also rely on accurate word timings to ensure viewers are able follow the conversation effectively. Certain ASR architectures, such as those employing Connectionist Temporal Classification (CTC) or Recurrent Neural Network Transducer (RNN-T) frameworks, inherently produce word-level timing information as a natural consequence of their transcription process. However, other prevalent ASR architectures that integrate a separate language model (LM) for enhanced accuracy and fluency typically do not readily provide such temporal information.

### SUMMARY

One aspect of the disclosure provides a computer-implemented method executed on data processing hardware that causes the data processing hardware to perform operations for training a speech recognition model with word-timings transcribed. The operations include obtaining training data that includes a plurality of training utterances each paired with a corresponding target output sequence. Each corresponding target output sequence includes a sequence of words and associated timestamps. Each timestamp indicates a timestamp associated with one of the words in the sequence of words of the target output sequence. For each respective training utterance of the plurality of training utterances, the operations include generating a corresponding audio encoding based on the respective training utterance using an audio encoder of a speech recognition model, generating a respective speech recognition result based on the corresponding audio encoding using a decoder of the speech recognition model, and determining a corresponding loss based on the corresponding target output sequence and the respective speech recognition result. The operations also include training the speech recognition model based on the corresponding loss determined for each respective training utterance of the plurality of training utterances.

Implementations of the disclosure may include one or more of the following optional features. In some implementations, the target output sequence includes one or more pause tokens each indicating a pause between adjacent words in the sequence of words. In these implementations, each timestamp may indicate an end time of a preceding word of the sequence of words or a preceding pause token. In some examples, each word of the sequence of words is represented by one or more wordpiece tokens of a set of wordpiece tokens and each timestamp is represented by one or more timestamp tokens of a set of timestamp tokens. The set of timestamp tokens is distinct from the set of wordpiece tokens. Here, the one or more timestamp tokens may be appended directly to a preceding wordpiece token without an intervening space token. In these examples, the timestamps may represent time values at a predetermined precision level, the predetermined precision level defines a time unit, and the timestamp tokens represent multiples of the time unit. In these examples, the timestamp tokens may represent digits in a numerical base greater than base-10.

In some implementations, for each respective training utterance of the plurality of training utterances, the operations further include determining the associated timestamps for the sequence of words using an audio-text alignment model. The decoder may include a sequence processing neural network. In some examples, the operations further include obtaining an input prompt that instructs the decoder to generate the respective speech recognition result including the associated timestamps. Here, generating the respective speech recognition result is further based on the input prompt.

Another aspect of the disclosure provides a system that includes data processing hardware and memory hardware storing instructions that when executed on the data processing hardware causes the data processing hardware to perform operations. The operations include obtaining training data that includes a plurality of training utterances each paired with a corresponding target output sequence. Each corresponding target output sequence includes a sequence of words and associated timestamps. Each timestamp indicates a timestamp associated with one of the words in the sequence of words of the target output sequence. For each respective training utterance of the plurality of training utterances, the operations include generating a corresponding audio encoding based on the respective training utterance using an audio encoder of a speech recognition model, generating a respective speech recognition result based on the corresponding audio encoding using a decoder of the speech recognition model, and determining a corresponding loss based on the corresponding target output sequence and the respective speech recognition result. The operations also include training the speech recognition model based on the corresponding loss determined for each respective training utterance of the plurality of training utterances.

Implementations of the disclosure may include one or more of the following optional features. In some implementations, the target output sequence includes one or more pause tokens each indicating a pause between adjacent words in the sequence of words. In these implementations, each timestamp may indicate an end time of a preceding word of the sequence of words or a preceding pause token. In some examples, each word of the sequence of words is represented by one or more wordpiece tokens of a set of wordpiece tokens and each timestamp is represented by one or more timestamp tokens of a set of timestamp tokens. The set of timestamp tokens is distinct from the set of wordpiece tokens. Here, the one or more timestamp tokens may be appended directly to a preceding wordpiece token without an intervening space token. In these examples, the timestamps may represent time values at a predetermined precision level, the predetermined precision level defines a time unit, and the timestamp tokens represent multiples of the time unit. In these examples, the timestamp tokens may represent digits in a numerical base greater than base-10.

In some implementations, for each respective training utterance of the plurality of training utterances, the operations further include determining the associated timestamps for the sequence of words using an audio-text alignment model. The decoder may include a sequence processing neural network. In some examples, the operations further include obtaining an input prompt that instructs the decoder to generate the respective speech recognition result including the associated timestamps. Here, generating the respective speech recognition result is further based on the input prompt.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example speech recognition system.

FIG. 2 is a schematic view of a speech recognition model.

FIG. 3 is a schematic view of an example training process for training the speech recognition model.

FIG. 4 is a flowchart of an example arrangement of operations for a computer-implemented method of training the speech recognition model with word-timings transcribed.

FIG. 5 is a schematic view of an example computing device that may be used to implement the systems and methods described herein.

Like reference symbols in the various drawings indicate like elements.

### DETAILED DESCRIPTION

Automatic Speech Recognition (ASR) systems generate text transcriptions from audio for a wide array of different applications. The primary output of an ASR system is typically a textual transcription of the speech detected in an input audio signal. However, for many downstream tasks and user experiences, the sequence of words alone is insufficient. That is, precise temporal information indicating when each word was spoken may be highly desirable or even essential. Applications such as synchronized text captioning for video content, real-time transcription displays for meetings and presentations, and searchable audio or video archives rely heavily on accurate word-level timing. In video captioning, for example, captions need to appear and disappear in close alignment with the corresponding spoken dialogue to provide an effective viewing experience. If the timing is inaccurate, captions may lag or appear too early, confusing the viewer and diminishing the utility of the captions. Similarly, in meeting transcription applications, accurate timestamps allow users to easily navigate the transcript, locate specific points in the audio recording corresponding to the text, and understand the flow of conversation, especially when multiple speakers are involved. Other areas benefiting from precise word timings include audio analysis, where timings may aid in speaker diarization or sentiment analysis tied to specific utterances, and voice-controlled systems, where understanding the timing of commands is relevant.

Some ASR system architectures naturally facilitate the extraction of word timing information. Frameworks based on Connectionist Temporal Classification (CTC) or Recurrent Neural Network-Transducers (RNN-T), for instance, often operate by making predictions aligned with frames or segments of the input audio, allowing word boundaries to be estimated as a byproduct of the main transcription process. However, many ASR systems utilize an architecture that includes an audio encoder, which processes the input audio into a sequence of feature representations, and a separate language model (LM) decoder, which generates the output text sequence based on the encoded audio features. The LM-based architecture, often leveraging transformer models or sequence-to-sequence frameworks, excels at producing fluent and contextually appropriate transcriptions. However, a common characteristic of these architectures is that the direct temporal correspondence between the input audio frames and the output word tokens is often lost or obscured during the decoding process. The LM decoder typically attends to the entire encoded audio sequence (or large portions thereof) when predicting each word, focusing on generating a linguistically probable sequence rather than strictly aligning output tokens to input time steps.

Consequently, extracting accurate word timings from the LM-based ASR systems presents a significant challenge. One common approach attempts to infer timings by analyzing the internal attention mechanisms within the LM decoder. The rationale is that the decoder may attend most strongly to the encoded audio features corresponding to the time segment when a particular word was spoken. However, this method frequently suffers from limited accuracy. There is no inherent guarantee that the encoded audio representation maintains a strict temporal alignment with the original raw audio, as the encoder may temporally smooth or distort the features. Moreover, attention mechanisms often integrate information from multiple parts of the encoded sequence simultaneously, meaning the attention weights may not sharply peak at the precise time location of a word. The effectiveness of attention-based timing extraction is also highly sensitive to the specific model design and training, and residual timing errors may be substantial, sometimes on the order of hundreds of milliseconds, which is unacceptable for many applications.

Accordingly, implementations herein are directed towards a training process that obtains training data that includes a plurality of training utterances each paired with a corresponding target output sequence. Each corresponding target output sequence includes a sequence of words and associated timestamps. Each timestamp indicates a timing associated with one of the words in the sequence of words of the target output sequence. For each respective training utterance of the plurality of training utterances, the training process includes generating a corresponding audio encoding based on the respective training utterance using an audio encoder, generating a respective speech recognition result based on the corresponding audio encoding using a decoder, and determining a corresponding loss based on the corresponding target output sequence and the respective speech recognition result. The training process trains a speech recognition model based on the corresponding loss determined for each respective training utterance of the plurality of training utterances.

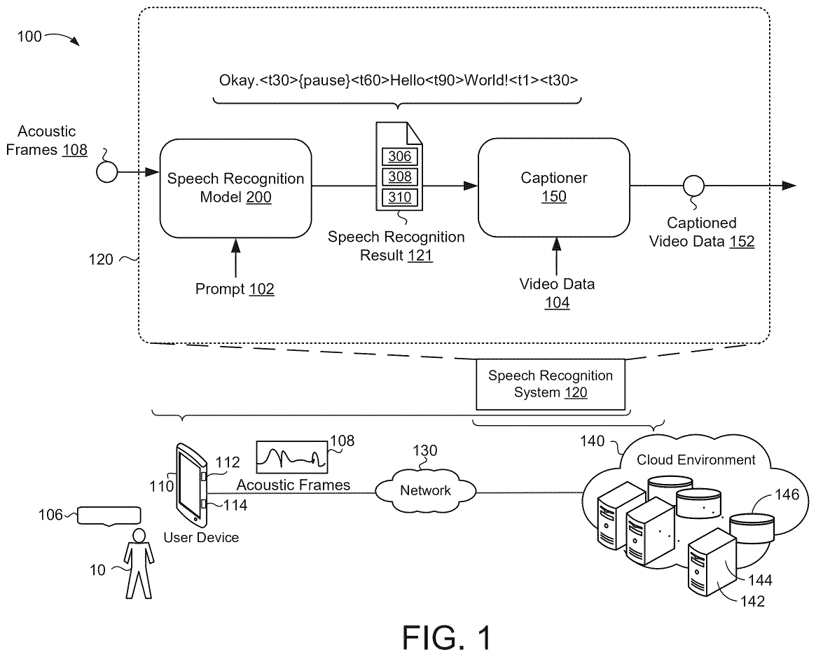

Referring to FIG. 1, a system 100 includes a user device 110 capturing speech utterances 106 spoken by one or more users 10 and communicating with a remote system 140 via a network 130. The remote system 140 may be a distributed system (e.g., cloud computing environment) having scalable/elastic resources 142. The resources 142 include computing resources 144 (e.g., data processing hardware) and/or storage resources 146 (e.g., memory hardware). The user device 110 and/or the remote system 140 execute a speech recognition system 120.

The user device 110 includes data processing hardware 112 and memory hardware 114. The user device 110 may include an audio capture device (e.g., microphone) for capturing and converting the speech utterances 106 (also referred to as simply “utterances 106”) from the multiple speakers 10 into the sequence of acoustic frames 108 (e.g., input audio data). In some implementations, the user device 110 is configured to execute a portion of the speech recognition system 120 locally (e.g., using the data processing hardware 112) while a remaining portion of the speech recognition system 120 executes on the remote system 140 (e.g., using data processing hardware 144). Alternatively, the speech recognition system 120 may execute entirely on the user device 110 or remote system 140. The user device 110 may be any computing device capable of communicating with the remote system 140 through the network 130. The user device 110 includes, but is not limited to, desktop computing devices and mobile computing devices, such as laptops, tablets, smart phones, smart speakers/displays, smart appliances, internet-of-things (IoT) devices, and wearable computing devices (e.g., headsets and/or watches).

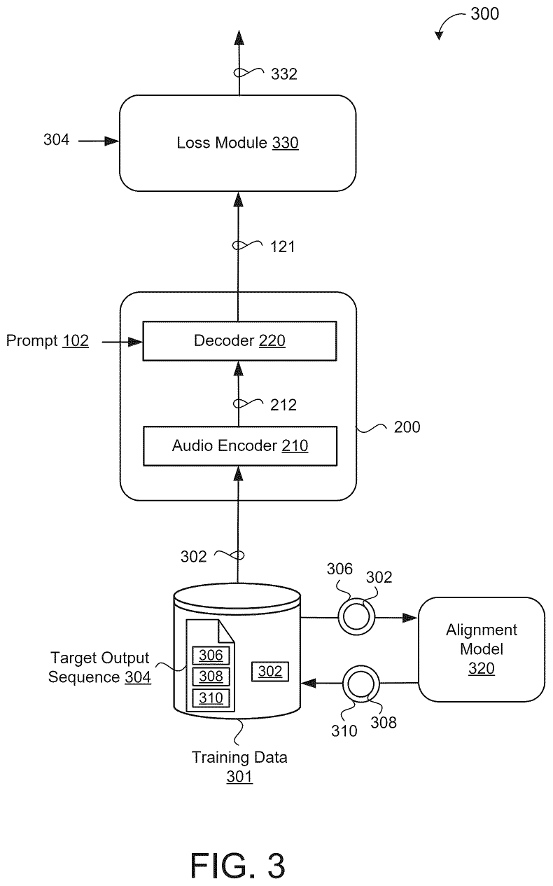

The speech recognition system 120 includes a speech recognition model 200 and a captioner 150. The speech recognition model 200 is configured to receive a sequence of acoustic frames 108 corresponding to a spoken utterance 106 and generate a speech recognition result 121. Notably, as discussed in greater detail with reference to FIG. 3, the speech recognition results 121 include both a sequence of words 306 representing the recognized linguistic content corresponding to the spoken utterance 106 and associated timestamps 308 generated by the same speech recognition model 200. Each timestamp 308 indicates a timing associated with one of the words 306 in the sequence of words 306 (e.g., the start time or end time of the word 306 relative to the beginning of the utterance 106). Optionally, the speech recognition results 121 may also include pause tokens 310 representing detected silences or pauses between words 306. In the example shown, for the utterance 106 “Okay. Hello World!”, assuming end times are predicted with a 10 millisecond (ms) precision and represented using base-100 timestamp tokens, a corresponding speech recognition result 121 may be represented as “Okay <t30>{pause}<t60>Hello<t90>World!<t1><t30>.” In this example, “Okay” ends at 300 ms, “{pause}” is the pause token 310 ending at 600 ms, “Hello” ends at 900 ms, and “World!” ends at 1300 ms.

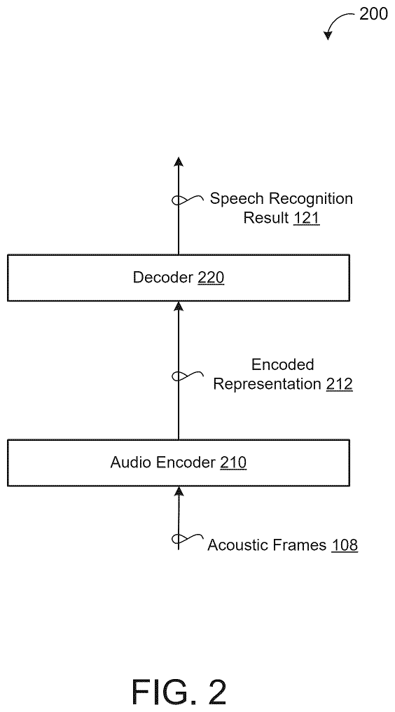

In some implementations, the speech recognition model 200 obtains an input prompt 102 instructing the speech recognition model 200 to generate the speech recognition results 121 to include the associated timestamps 308. The input prompt 102 serves as a directive that guides the speech recognition model 200 to generate the speech recognition results 121 in the desired output format. As such, the input prompt 102 distinguishes the output from the speech recognition model 200 from other potential tasks that the speech recognition model 200 may perform, such as transcriptions without timing, translation, or summarization. For instance, the input prompt 102 may be a natural language instruction such as “Transcribe the following audio and provide word-level timestamps.” Here, the speech recognition model 200 generates the speech recognition result 121 further based on the input prompt 102. That is, the presence and content of the input prompt 102 conditions the decoder 220 (FIG. 2) to activate the mechanism for predicting and outputting the sequence of words 306 interspersed with the appropriate timestamp tokens (e.g., representing timestamps 308) and/or pause tokens 310, rather than just outputting the words 306 alone. Without such a specific timing-related input prompt 102, the same speech recognition model 200, when processing the same sequence of acoustic frames 108, may default to generating a non-timestamped transcript.

The captioner 150 is configured to receive the speech recognition results 121 (e.g., including the sequence of words 306, the timestamps 308, and/or the pause tokens 310) and corresponding multimedia data, such as video data 104. The multimedia data represents the context in which the speech utterances 106 occurred and may encompass various different forms. The multimedia data may include meeting data, such as audio and/or video data captured during an online meeting or teleconference meeting. For example, the speech recognition system 120 may process the sequence of acoustic frames 108 from a multi-participant video conference hosted on a meeting platform to generate captions or a time-aligned meeting transcript. Alternatively, the multimedia data may be video data 104 intended for various video applications, such as user-generated content uploaded to a video-sharing platform. The multimedia data may be temporally associated with the spoken utterances 106 that generated the speech recognition results 121. For instance, in the context of meeting data, the audio data includes the utterances 106 and any accompanying video stream shows the participants speaking or presenting content. In the context of video applications, the video data 104 may depict the user 10 (or multiple users 10) speaking the utterance 106, or display related content being discussed or narrated.

To that end, the captioner 150 may generate captioned output, such as captioned video data 152 or other forms of time-aligned textual representations. This may involve synchronizing and overlaying the textual content derived from the speech recognition results 121 onto the video data 104. The synchronization may include aligning the timestamps 308 from the speech recognition result 121 with timecodes of the video data 104, ensuring that words appear on screen concurrently with being spoken. In some examples, other multimedia content other than video data 104 may be used in addition to, or in lieu of, the video data 104. For instance, the multimedia content may be an audio-only recording where the captioner 150 generates a time-aligned transcript file, or a presentation slide deck where the recognized speech is added as synchronized speaker notes or overlaid captions. The captioned video data 152 may be transmitted to the user device 110 and output from the user device 110. For instance, the user device 110 may display the video and audibly output the sounds of the video while displaying the captions on a screen of the user device 110.

FIG. 2 illustrates an example speech recognition model 200 which includes an audio encoder 210 and a decoder 220. The decoder 220 may include a sequence processing neural network. In some examples, the sequence processing neural network includes a large language model (LLM). For simplicity, the present disclosure will refer to the sequence processing neural network as an LLM, however, the sequence processing neural network may include other types of sequence processing neural networks other than LLMs without departing from the scope of the present disclosure. In this architecture, the audio encoder 210 processes the raw audio (e.g., acoustic frames 108) into encoded representation 212. The speech recognition model 200 provides the encoded representations 212 as input or context (e.g., as part of the input prompt 102) to the LLM decoder 220.

The audio encoder 210 reads a sequence of d-dimensional feature vectors (e.g., acoustic frames 108 (FIG. 1) x=(x₁, x₂, . . . , x_{T}), where x₁∈R_{d}, and produces at each output step an encoded representation 212. The decoder 220 receives the encoded representations 212, as input, and generates the speech recognition result 121 based on the encoded representation 212 and/or the input prompt 102. The combination of the audio encoder 210 and the decoder 220 allows for an end-to-end speech recognition model 200 that leverages both acoustic modeling (via the audio encoder 210) and language modeling (via the decoder 220). This contrasts with architectures such as RNN-T where the decoder operates more sequentially in time with the encoder output. In some implementations, the architecture of the speech recognition model 200 includes a prediction network (not shown) which, like a language model (LM), processes the sequence of non-blank symbols output by a final Softmax layer so far into a dense representation. In these implementations, the representations produced by the audio encoder 210 and the prediction network are combined by the decoder 220 whereby the decoder 220 serves as a joint network from a Recurrent Neural Network-Transducer (RNN-T) model architecture.

FIG. 3 illustrates a training process 300 for training the speech recognition model 200 to generate words 306 and timestamps 308. The training process 300 employs an optional audio-text alignment model 320, the speech recognition model 200 (e.g., including the audio encoder 210 and the decoder 220), and a loss module 330. The training process 300 obtains training data 301 that includes a plurality of training utterances 302, such as individual sentences or phrases extracted from audio recordings. Each training utterance 302 may be represented by a sequence of acoustic frames 108 (FIG. 1). Sources for the training data 301 may include manually transcribed and time-aligned speech corpora (e.g., broadcast news archives, read speech datasets) or data aligned using the audio-text alignment model 320. Each training utterance 302 is paired with a corresponding target output sequence 304, which serves as the ground-truth label or desired prediction for the training utterance 302. Notably, each corresponding target output sequence 304 includes both a sequence of words 306 representing the linguistic content and associated timestamps 308 indicating the timing of the words 306 within the training utterance 302, formatted in the specific way the speech recognition model 200 is intended to learn. The timestamps 308 may indicate the end time of a word 306, the start time of a word 306, or both the start and end times of the word 306. However, representing only end times is more efficient in terms of output sequence length.

Each word 306 within the sequence of words 306 is represented by one or more wordpiece tokens. Wordpiece tokens are sub-word units (e.g., “speech”, “recogni”, “tion” for the word “speech recognition”) that allow the speech recognition model 200 to handle large vocabularies, including rare words, proper nouns, or variations, more effectively than using whole words as tokens. Each timestamp 308 indicates a timing associated with one of the words 306 (or potentially a pause, as discussed below) in the sequence of words 306 of the target output sequence 304. For example, if representing only end times, a target output sequence 304 for the training utterance 302 of “Hello world!” where “Hello” ends at 200 milliseconds (ms) and “world!” ends at 500 ms relative to the start of the training utterance 302 may be represented textually as “Hello_200 world!_500. Alternatively, if representing start and end times, the same training utterance 302 may be represented as “_50 Hello_200 World!_500.” For simplicity, the disclosure herein describes the timestamps 308 representing only the end times of words 306. Here, the start time of a word 306 may be inferred as the end time of the preceding element (e.g., word 306 or pause token 310). While not always perfectly accurate, especially across silences, this simplification significantly reduces the output token count.

In some examples, to better model the natural pauses and rhythm of speech and to improve the accuracy of inferred start times (e.g., where the end time of a preceding element is inferred as the approximate start time for the subsequent element when only end times are predicted), the target output sequence 304 also includes one or more pause tokens 310, such as a special pause token (e.g., “{pause”). Each pause token indicates a pause or silence interval between adjacent words 306 in the sequence of words 306. Modeling pauses explicitly allows the speech recognition model 200 to account for non-speech intervals, leading to more accurate timing information which is valuable for applications such as transcription alignment and naturalness in generated captions. The pause token 310 may be treated similarly to a word token in that the pause token 310 is associated with an end time timestamp 308, representing the end time of the pause itself. As such, each timestamp 308 may indicate an end time of a preceding word 306 of the sequence of words or a preceding pause token 310. For instance, if there was a 200 ms pause between “Hello” (ending at 200 ms) and “world!” (starting after the pause at 400 ms and ending at 700 ms), the target output sequence 304 indicating end times may be represented as “Hello_200 {pause}_400 world!_700.” Here, including the pause token and its end time prevents the speech recognition model 200 from incorrectly inferring that “World!” starts immediately after 200 ms and provides a more accurate inferred start time (400ms) for “World!”

Moreover, each timestamp 308 is represented by one or more timestamp tokens (e.g., <tN>) of a set of timestamp tokens. The set of timestamp tokens is distinct from the set of wordpiece tokens. The set of timestamp tokens is deliberately distinct from the set of wordpiece tokens used to represent linguistic content. This distinction is important for unambiguous parsing, allowing the speech recognition model 200 and any downstream parsing logic to differentiate between linguistic content and timing information. For example, without distinct tokens, the sequence “read 200 pages” would be ambiguous if “200” could represent either the number two hundred or a timestamp 308 of 200 time units. Using a distinct token, such as “<t20>” (or perhaps “<t2><t0><t0>” depending on the base and precision) for the timestamp 308 resolves this ambiguity. Using a dedicated set of timestamp tokens allows the model and downstream parsing logic to easily differentiate between linguistic content (words, including numbers like “$200”) and timing information, preventing ambiguity. Notably, the one or more timestamp tokens representing a specific time value are appended directly to the final wordpiece token of the preceding word (or the pause token) without an intervening space token. This direct appending, enabled by the distinct nature of timestamp tokens, further improves efficiency by eliminating the need for the model to generate space tokens between words/pauses and their associated timestamps, reducing the overall sequence length the speech recognition model 200 needs to process and generate, as space tokens often require the speech recognition model to generate an additional token.

The timestamps 308 within the target output sequence 304 represent time values at a predetermined precision level whereby the predetermined precision level defines a discrete time unit. Choosing an appropriate precision level is important as it involves a trade-off between temporal accuracy and sequence length (and thus computational cost). Representing time with millisecond precision may be necessary for fine-grained phonetic analysis but requires many tokens per timestamp 308 (e.g., representing 15.321 second may require tokens for 1, 5, 3, 2, and 1 if using 1 ms prediction and base-10). However, many applications (e.g., captioning videos) may only require precision to the nearest few tens of milliseconds (e.g., 10 ms, 20 ms, 40 ms). Moreover, the speech recognition model 200 itself may not be capable of accurately predicting millisecond-level timing reliably. Therefore, choosing a coarser precision (e.g., 40 ms or 50 ms) significantly reduces the number of timestamp tokens needed without sacrificing practical accuracy for many configurations. For example, the time unit may be 10 ms, meaning all timestamps 308 are rounded to the nearest 10 ms. In other examples, the time unit may be 40 ms or 50 ms.

Consequently, the timestamp tokens represent multiples of the discrete time unit. For instance, if the time unit is 40 ms, a sequence of timestamp tokens representing the numerical value “5” corresponds to 200 ms (5*40 ms) relative to the start of the training utterance 302 or a previous time point, depending on the particular implementation. In some examples, to achieve a more compact representation of time values and further reduce the number of tokens the speech recognition model 200 needs to generate per timestamp 308, the timestamp tokens represent digits in a numerical base greater than base-10, such as base-64 or base-100. Using a higher base allows a wider range of time values to be represented with fewer tokens, potentially improving prediction efficiency. For example, representing an end time of 500 ms using a 10 ms time unit requires representing the value “50.” In base-10 using dedicated timestamp tokens such as “<t0>” to “<t9>,” this would require two tokens “<t5><t0>.” However, if using a base-100 system with dedicated tokens “<t0>” to “<t99>,” the same value “50” may be represented with a single token “<t50>.” Similarly, a value such as “125” (e.g., representing 1.25 seconds if the unit is 10 ms) may require three tokens in base-10“<t1><t2><t5>” but only two tokens in base-100 (e.g., “<t1><t25>” where “<t1>” represents 1100 and “<t25>” represents 251). By combining higher bases and appropriate precision (e.g., base-64 and 40 ms precision), timestamps spanning hours are represented using only a few tokens (e.g., three or four timestamp tokens), making the generation of timestamped transcripts significantly more efficient.

In some scenarios, training data 301 with accurate, pre-existing timestamps 308 and pause tokens 310 is not readily available or is available only in limited quantities. That is, initially the training data 301 may only include training utterances 302 paired with the sequence of words 306 (i.e., plain transcripts). To address this and augment the available training data, the audio-text alignment model 320 may be employed. The audio-text alignment model 320, which may be a separate system like a Hidden Markov Model (HMM)-based forced aligner, or another neural network trained for alignment, takes the audio of a training utterance and its corresponding transcript (e.g., sequence of words 306) as input. For each respective training utterance 302, the alignment model 320 automatically estimates and determines the associated timestamps 308 and/or the pause tokens 310 for the sequence of words 306 in the desired target format (e.g., end times, specific precision, base representation). This process allows leveraging large corpora of transcribed audio that lack fine-grained timing information, thereby enriching the training data 301 used to train the speech recognition model 200 to predict timestamps 308. Generating the aligned data represents a one-time cost during the training process 300, enabling the trained speech recognition model 200 to directly output both text and timings without needing a separate alignment step during inference.

The training process 300 proceeds iteratively over the training data 301 or batches of the training data 301. The training process 300 may involve fine-tuning a pre-trained speech recognition model 200. For each respective training utterance 302 (or batch thereof) within the training data 301, the audio encoder 210 of the speech recognition model 200 generates a corresponding audio encoding 212 based on the respective training utterance 302. Notably, the decoder 220 is trained to generate the speech recognition result 121 in the same format as the target output sequence 304 (i.e., including wordpiece tokens, timestamp tokens, and/or pause tokens). Thus, the decoder 220 of the speech recognition model 200 generates a respective speech recognition result 121 for the respective training utterance 302 based on the corresponding audio encoding 212. In some implementations, the speech recognition model 200 obtains an input prompt 102 instructing the decoder 220 to generate the respective speech recognition result 121 including the associated timestamps 308 (e.g., “transcribe the following audio with timestamps”), distinguishing this task from other tasks the speech recognition model 200 may be capable of. Here, the decoder 220 generates the speech recognition results 121 further based on the input prompt 102.

The loss module 330 determines a loss 332 based on the corresponding target output sequence 304 and the respective speech recognition result 121. That is, the loss module 330 compares the corresponding target output sequence 304 (e.g., the ground-truth label) and the respective speech recognition result 121. The loss 332 quantifies the discrepancy or error between the prediction and the target. Specifically, the comparison assesses the accuracy of the speech recognition results 121 token by token. The loss function penalizes discrepancies such as incorrect wordpiece tokens (reflecting transcription errors), incorrect timestamp tokens (reflecting timing errors, where the penalty may potentially scale with the magnitude of the timing deviation), and the incorrect prediction or omission of pause tokens 310 (reflecting errors in identifying non-speech intervals or their duration via associated timestamp tokens). Common loss metrics such as cross-entropy may be applied across the entire predicted sequence of tokens (wordpiece, timestamp, pause), effectively treating each token prediction as a classification task. Alternatively, sequence-level metrics such as edit distance may be adapted for the combined word and timestamp sequence, assigning different loss values to errors involving wordpiece tokens versus timestamp tokens versus pause tokens. The training process 300 trains the speech recognition model 200 (adjusting the parameters of the decoder 220 and/or the audio encoder 210) based on the loss 332. Training may involve techniques such as backpropagation and optimization algorithms (e.g., Stochastic Gradient Descent, Adam) to minimize the loss 332 over the entire training dataset 301.

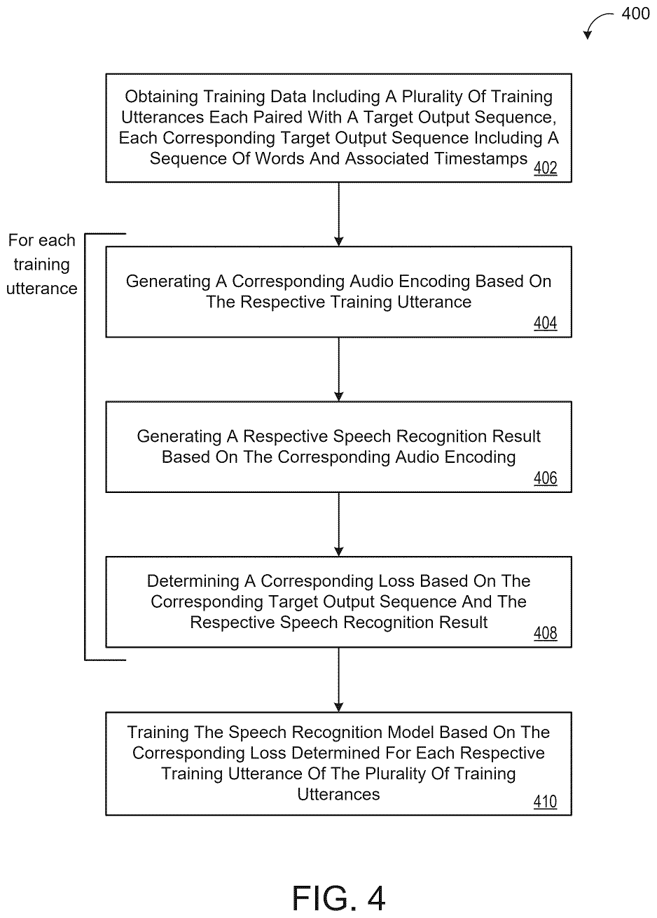

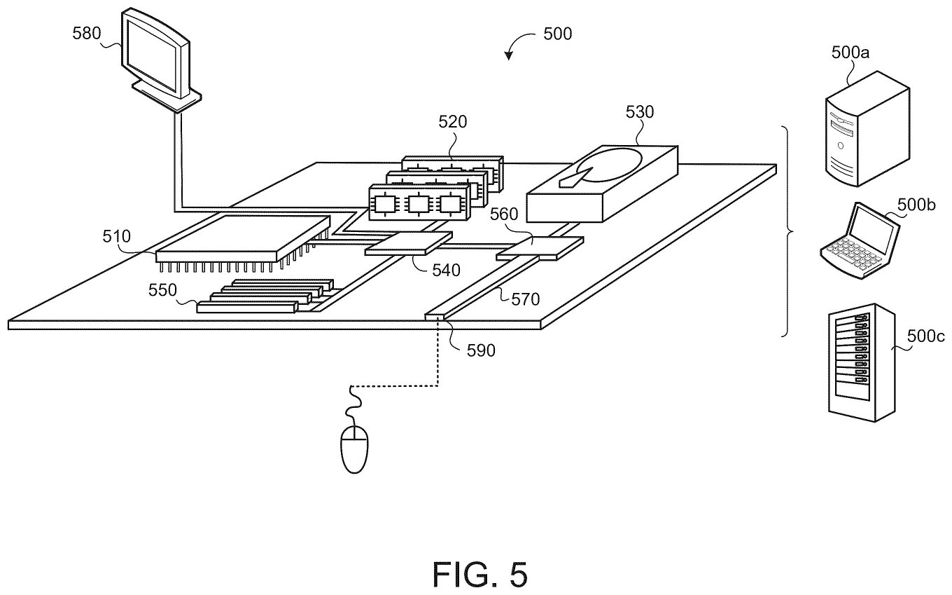

FIG. 4 includes a flowchart of an example arrangement of operations for a computer-implemented method 400 of training a speech recognition model 200 with word-timings transcribed. The method 400 may execute on data processing hardware 510 (FIG. 5) using instructions stored on memory hardware 520 (FIG. 5) that may reside on the user device 110 and/or the remote system 140 of FIG. 1 corresponding to a computing device 500 (FIG. 5).

At operation 402, the method 400 includes obtaining training data 301 that includes a plurality of training utterances 302 each paired with a corresponding target output sequence 304. Each corresponding target output sequence 304 includes a sequence of words 306 and associated timestamps 308. Each timestamp 308 indicates a timing associated with one of the words 306 in the sequence of words 306 of the target output sequence 304. For each respective training utterance 302 of the plurality of training utterances 302, the method 400 performs operations 404-408. At operation 404, the method 400 includes generating, using an audio encoder 210 of a speech recognition model 200, a corresponding audio encoding 212 based on the respective training utterance 302. At operation 406, the method 400 includes generating, using a decoder 220 of the speech recognition model 200, a respective speech recognition result 121 based on the corresponding audio encoding 212. At operation 408, the method 400 includes determining a corresponding loss 332 based on the corresponding target output sequence 304 and the respective speech recognition result. At operation 410, the method 400 includes training the speech recognition model 200 based on the corresponding loss 332 determined for each respective training utterance 302 of the plurality of training utterances 302.

FIG. 5 is a schematic view of an example computing device 500 that may be used to implement the systems and methods described in this document. The computing device 500 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510, memory 520, a storage device 530, a high-speed interface/controller 540 connecting to the memory 520 and high-speed expansion ports 550, and a low-speed interface/controller 560 connecting to a low-speed bus 570 and a storage device 530. Each of the components 510, 520, 530, 540, 550, and 560, are interconnected using various busses, and may be mounted on a common motherboard or in other manners as appropriate. The processor 510 can process instructions for execution within the computing device 500, including instructions stored in the memory 520 or on the storage device 530 to display graphical information for a graphical user interface (GUI) on an external input/output device, such as display 580 coupled to high-speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer-or machine-readable medium, such as the memory 520, the storage device 530, or memory on processor 510.

The high-speed controller 540 manages bandwidth-intensive operations for the computing device 500, while the low-speed controller 560 manages lower bandwidth-intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 500a or multiple times in a group of such servers 500a, as a laptop computer 500b, or as part of a rack server system 500c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executed on data processing hardware that causes the data processing hardware to perform operations comprising:
obtaining training data comprising a plurality of training utterances each paired with a corresponding target output sequence, each corresponding target output sequence comprising a sequence of words and associated timestamps, each timestamp indicating a timing associated with one of the words in the sequence of words of the target output sequence;
for each respective training utterance of the plurality of training utterances:
generating, using an audio encoder of a speech recognition model, a corresponding audio encoding based on the respective training utterance;
generating, using a decoder of the speech recognition model, a respective speech recognition result based on the corresponding audio encoding; and
determining a corresponding loss based on the corresponding target output sequence and the respective speech recognition result; and
training the speech recognition model based on the corresponding loss determined for each respective training utterance of the plurality of training utterances.

2. The computer-implemented method of claim 1, wherein the target output sequence comprises one or more pause tokens each indicating a pause between adjacent words in the sequence of words.

3. The computer-implemented method of claim 2, wherein each timestamp indicates an end time of a preceding word of the sequence of words or a preceding pause token.

4. The computer-implemented method of claim 1, wherein:
each word of the sequence of words is represented by one or more wordpiece tokens of a set of wordpiece tokens, and
each timestamp is represented by one or more timestamp tokens of a set of timestamp tokens, the set of timestamp tokens distinct from the set of wordpiece tokens.

5. The computer-implemented method of claim 4, wherein the one or more timestamp tokens are appended directly to a preceding wordpiece token without an intervening space token.

6. The computer-implemented method of claim 4, wherein:
the timestamps represent time values at a predetermined precision level;
the predetermined precision level defines a time unit; and
the timestamp tokens represent multiples of the time unit.

7. The computer-implemented method of claim 4, wherein the timestamp tokens represent digits in a numerical base greater than base-10.

8. The computer-implemented method of claim 1, wherein the operations further comprise, for each respective training utterance of the plurality of training utterances, determining the associated timestamps for the sequence of words using an audio-text alignment model.

9. The computer-implemented method of claim 1, wherein the decoder comprises a sequence processing neural network.

10. The computer-implemented method of claim 1, wherein the operation further comprise:
obtaining an input prompt instructing the decoder to generate the respective speech recognition result including the associated timestamps,
wherein generating the respective speech recognition result is further based on the input prompt.

11. A system comprising:
data processing hardware; and
memory hardware in communication with the data processing hardware, the memory hardware storing instructions that when executed on the data processing hardware cause the data processing hardware to perform operations comprising:
obtaining training data comprising a plurality of training utterances each paired with a corresponding target output sequence, each corresponding target output sequence comprising a sequence of words and associated timestamps, each timestamp indicating a timing associated with one of the words in the sequence of words of the target output sequence;
for each respective training utterance of the plurality of training utterances:
generating, using an audio encoder of a speech recognition model, a corresponding audio encoding based on the respective training utterance;
generating, using a decoder of the speech recognition model, a respective speech recognition result based on the corresponding audio encoding; and
determining a loss based on the corresponding target output sequence and the respective speech recognition result; and
training the speech recognition model based on the loss determined for each respective training utterance of the plurality of training utterances.

12. The system of claim 11, wherein the target output sequence comprises one or more pause tokens each indicating a pause between adjacent words in the sequence of words.

13. The system of claim 12, wherein each timestamp indicates an end time of a preceding word of the sequence of words or a preceding pause token.

14. The system of claim 11, wherein:
each word of the sequence of words is represented by one or more wordpiece tokens of a set of wordpiece tokens; and
each timestamp is represented by one or more timestamp tokens of a set of timestamp tokens, the set of timestamp tokens distinct from the set of wordpiece tokens.

15. The system of claim 14, wherein the one or more timestamp tokens are appended directly to a preceding wordpiece token without an intervening space token.

16. The system of claim 14, wherein:
the timestamps represent time values at a predetermined precision level;
the predetermined precision level defines a time unit, and
the timestamp tokens represent multiples of the time unit.

17. The system of claim 14, wherein the timestamp tokens represent digits in a numerical base greater than base-10.

18. The system of claim 11, wherein the operations further comprise, for each respective training utterance of the plurality of training utterances, determining the associated timestamps for the sequence of words using an audio-text alignment model.

19. The system of claim 11, wherein the decoder comprises a sequence processing neural network.

20. The system of claim 11, wherein the operation further comprise:
obtaining an input prompt instructing the decoder to generate the respective speech recognition result including the associated timestamps,
wherein generating the respective speech recognition result is further based on the input prompt.
